(19) United States
(12) Patent Application Publication
(10) Pub. No.: US 2016/0257358 A1
(43) Pub. Date: Sep. 8, 2016

(54) SNOW TREAD AND CLEAT SYSTEM FOR SKIDSTEER IMPLEMENTS

(71) Applicant: Nathan Winscot Johnson, Lindstrom, MN (US)

(72) Inventor: Nathan Winscot Johnson, Lindstrom, MN (US)

(21) Appl. No.: 15/063,342

(22) Filed: Mar. 7, 2016

Related U.S. Application Data
(60) Provisional application No. 62/129,935, filed on Mar. 8, 2015.

(51) Int. Cl. B62D 55/28; B62D 55/32; B62D 55/24

(52) U.S. Cl. CPC B62D 55/28; B62D 55/24; B62D 55/286; B62D 55/32; E02F 9/02

(57) ABSTRACT

The presently claimed invention comprises an endless, flexible, track for use on track-driven implements comprising an inner surface with modular drive lugs to engage a driving mechanism of the implement. The modular drive lugs are mounted to the inner surface of the track and have through-holes to receive a fastening means. Situated on the outer, terrain-contacting surface of the endless track are interchangeable traction cleats spanning the width of the track. According to some embodiments, the outer surface may be slick rubber surface so as to provide maximum flotation for the skidsteer and minimal penetration to the surface. This is especially applicable to low traction surfaces such as snow.

### CROSS_REFERENCE TO PENDING APPLICATIONS

This application claims the benefit of U.S. Provisional Application No. 62/129935, filed Mar. 8, 2015.

### FIELD OF THE INVENTION

The present disclosure relates generally to a rubber belted track for skidsteer implements, and more particularly to a rubber belted track with metal cleats to provide traction to skidsteer implements on snow. Still more particularly, the present disclosure relates to a rubber belted skid steer track with metal cleats to grip snow-covered surfaces, especially inclines, and a smooth tread pattern to provide for flotation of the skidsteer implement.

### BACKGROUND OF THE INVENTION

Skidsteer is the general term for a small piece of heavy machinery with a low center of gravity. Skidsteers typically have one seat for an operator, a coupling plate on the front allowing the use of multiple attachments, and a diesel engine mounted behind the operator cab. They are zero-turn-radius vehicles, with steering being accomplished by varying the amount of power sent to each side. When full forward power is directed to a side and full reverse-power is directed to the opposite side, the machine will turn in a zero radius.

Skidsteers are produced by many companies including, but not limited to, Bobcat™, Terex™, John Deere™, and Caterpillar™. They are configured in all-wheel-drive models with four tires or track-driven models operated by a pair of belted tracks running on rollers that propel the machine.

The treads of both the wheeled and track-driven versions are typically deep to maximize the gripping force. This ensures that the vehicle remains stable under a variety of conditions while carrying loads up to the maximum rated capacity. Specialty treads are commercially available, such as tracks that fit over wheeled models and slick tracks for use in golf course maintenance designed for mar-free travel over turf.

### BRIEF SUMMARY OF THE INVENTION

In one or more embodiments, the skidsteer implement tracks may include cleats bolted onto the surface of a belted rubber track. Exemplary securing means for the cleats may include surface bolts, bolting from the cleat through the belt to drive lugs, or by an overmolding process. The cleats serve to enhance the traction of the implement on ice, snow, marsh, permafrost, and other terrains not typically served by presently available skidsteer configurations or aftermarket implement track applications.

### BRIEF DESCRIPTION OF THE SEVERAL VIEWS OF THE DRAWINGS

FIG. 1 depicts a side view of an aspect of the invention installed on a track-driven skidsteer implement.

FIG. 2 is a rear view of an embodiment that is a two-belt endless track with a gap, installed on a track-driven skidsteer implement.

FIG. 3 is a side view of a L-shaped traction cleat mounted to an endless belt with modular drive lugs.

FIG. 4 is a top view of an endless track belt with a gap spanned by a traction cleat, secured to the belt with a modular drive lug.

FIG. 5 depicts a side view of an endless belt track with an L-shaped traction cleat equal to the width of the endless belt.

FIG. 6 depicts an L-shaped traction cleat with a U-shaped profile for minimizing the contact surface between the cleat and the surface the skidsteer is travelling over.

FIG. 7 depicts an isometric view of a square-shaped traction cleat mounted to a segment of an endless track.

FIG. 8 depicts an endless track belt with traction cleats mounted in a horizontally staggered configuration.

FIG. 9 depicts an endless track belt with traction cleats designed for installation on four-wheel driven skidsteer implements.

### DETAILED DESCRIPTION OF THE INVENTION

This track system is designed to fit Multi Terrain Loaders (MTL's) or Compact Track Loaders (CTL's) to date manufactured by ASV, Caterpillar and Terex specifically with little or no modification to the base machine. The tracks are made up of a set of drive lugs to engage the drive system of the machine that are bolted, molded or fastened in one way or another to a reinforced rubber belt. The track, or interchangeably referred to as a belt, may be of a molded endless construction or made up of a two ended flat belt joined together into a loop by a variety of means comprising: a mechanical splice, a tapered lap joint, a vulcanized splice, a laced joint, etc. The outer surface of the belt is smooth and flat to accept the fastening of traction cleats or grousers.

These cleats may be of a multitude of materials and profiles to maximize traction and longevity on the intended primary ground conditions seen in use. The tracks's overall width may be equivalent to the general-purpose endless belt tracks provided by the Original Equipment Manufacturer (OEM) of the machine or wider than the OEM tracks. An aspect of the invention using tracks wider than the OEM offerings is constructed in an asymmetrical fashion, that is the additional width extends only past the outside edge of the endless track, and not evenly over the outside edge and the inside edge adjacent to the cab of the machine. The asymmetrical width is not as wide as the segment of the endless track that is in contact with the drive means of the skidsteer. In the art of tracked and wheeled machinery, traction cleats are also known as grousers and defined as a protrusion on the surface of a wheel or continuous track segment.

The purpose of this invention is to increase the versatility of compact track loaders by allowing them to safely and efficiently operate on terrain that was previously impassable; for example: snow, ice, tundra, and permafrost terrains. This will extend the working season of this type of machine allowing owners to access jobsites in soft terrain bases and/or low traction conditions.

The present disclosure, in some embodiments, includes a belt for use on track-driven implement machines with a molded rubber driven/grouser surface, polymer-reinforced belting, a molded rubber terrain surface, and attached metal cleats for gripping snow covered surfaces. The metal cleats may be secured to the rubber terrain surface via a mechanical fastening or an overmolding means. The rubber track density and dimensions permit the skidsteer implement to remain buoyant so as to move freely across a multitude of terrain conditions. The cleats are constructed from metal according to certain embodiments. The metal-cleated track serves to provide reliable traction to belt-driven implements on snow terrain. Unlike metal-link or over-the-tire rubber style tracks for mounting on four-wheeled skidsteers, the snow track utilizes the balanced weight, direct-drive and suspension advantages of a track-driven machine.

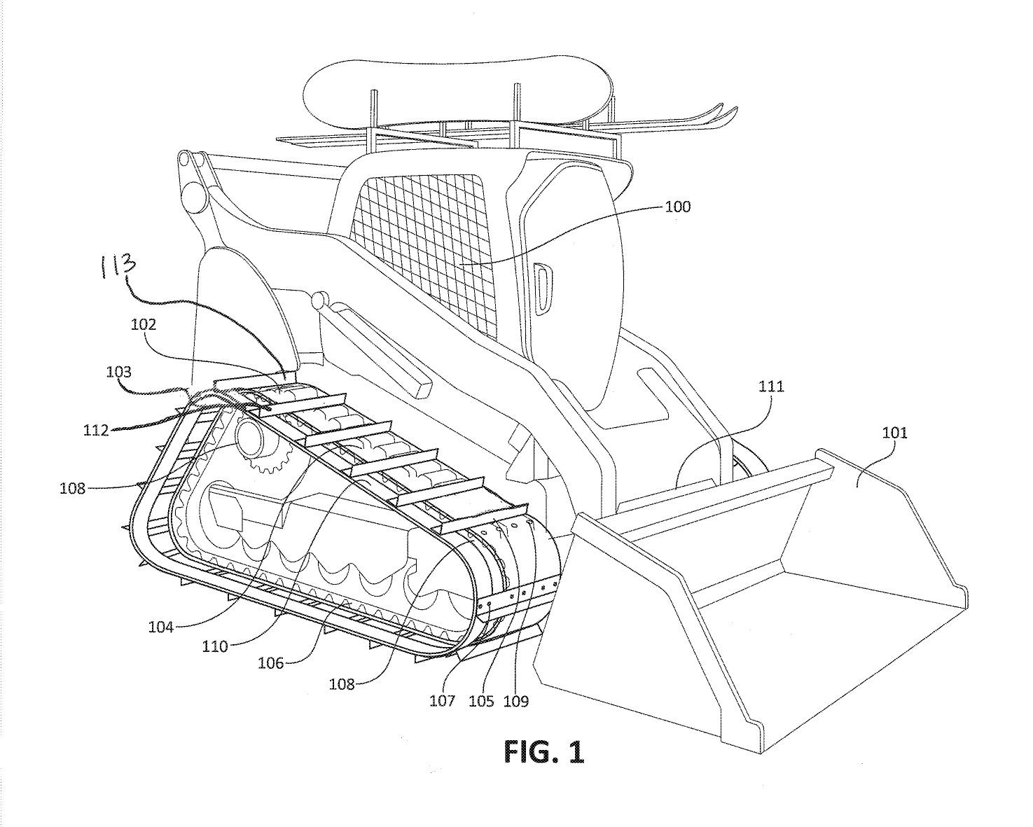

An isometric view of a skidsteer 100 fitted with smooth-surface endless tracks 102 is depicted in FIG. 1. A general-purpose bucket 101 is connected to the OEM coupling plate 111. The outer, smooth-surface endless track 102 has an inner surface 103 for mating with the drive rollers 108 of the skidsteer 100. The endless track 102 is comprised of a wide inner track 104 and a narrow outer track 110 separated by a gap 108 that is open through the inner 103 and outer surfaces of the endless track 102. The aspect of the invention has traction cleats 105 mounted to the endless track 102 belt via mechanical fasteners 107 that pass through holes 109 in the cross-section of the belt 102. According to some aspects, the traction cleats 105 are secured to drive lugs 106, which may be modular or may be molded with the inner surface 103 of the belt. The traction cleats have a horizontal segment 112 for mating to the belt 102 and a vertical segment 113 for contacting the terrain and providing improved traction for the skidsteer implement 100 on certain terrain conditions.

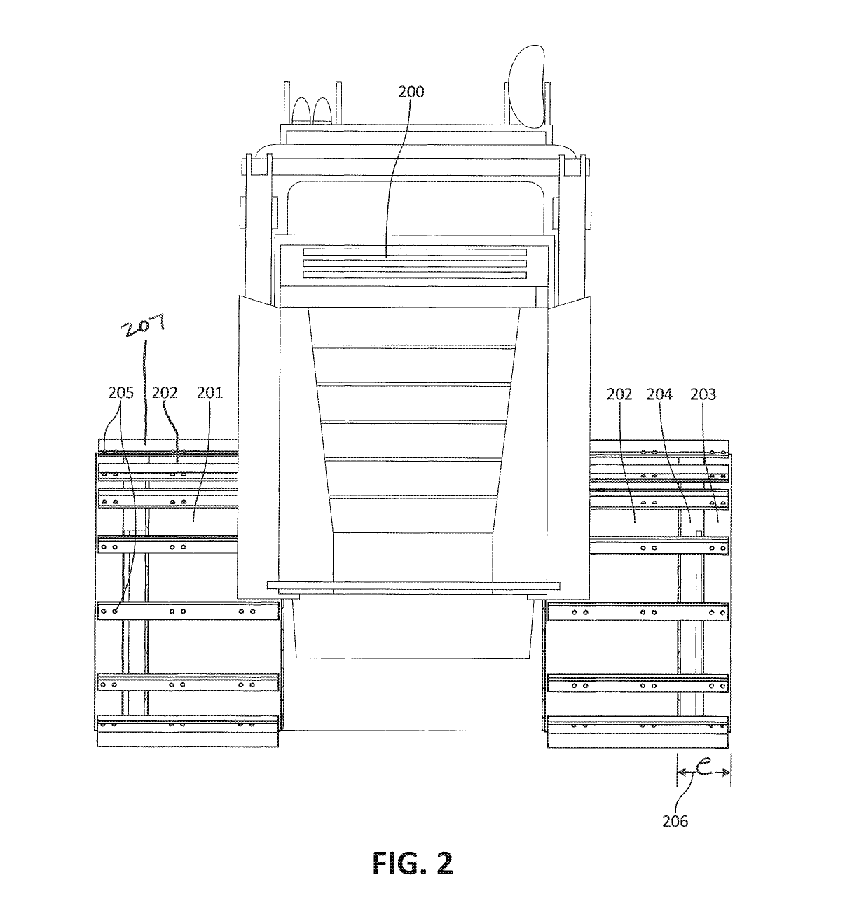

A rearview of a skidsteer implement 200 is shown in FIG. 2. The OEM track has been replaced with an endless track 201 with traction cleats 207, according to certain aspects of the invention. The example embodiment has an inner track 202 with a width similar to the OEM track, and an outer track 203 that is connected to the inner track 202 via the traction cleats 207. The gap 204 between the inner track 202 and the outer track 203 is approximately equal to the width of the outer track 203. The extended width of the track is shown as dimension “e” 206. The extended width 206 on both sides of the skidsteer 200 serves to increase the floatation of the skidsteer 200 on challenging terrain conditions. The traction cleats 207 are secured to the inner 202 and outer 203 belts via mechanical fastening means 205.

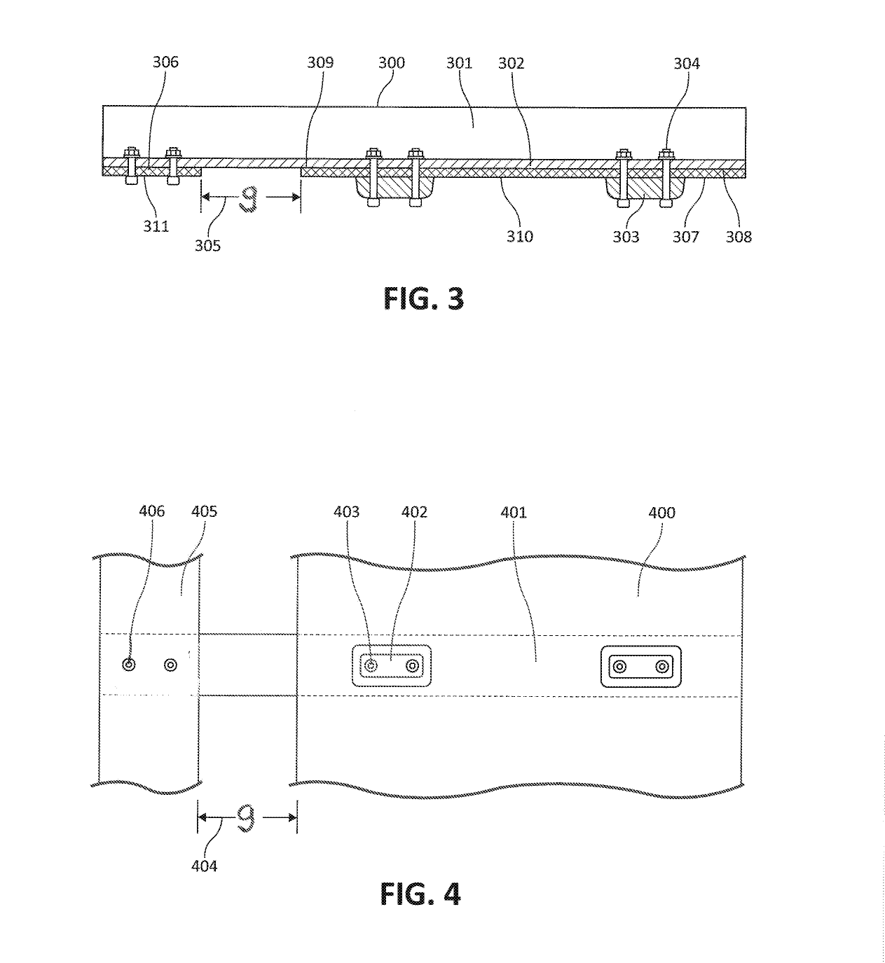

FIG. 3 depicts a close-up view of a traction cleat 300 secured to an endless belt 309. The traction cleat 300 mates to the outer surface 308 of the endless belt 309 while drive lugs 303 mate to the inner surface 307. Specifically, the horizontal surface 302 of the traction cleat mates to the outer surface 308 permitting the vertical surface 301 to extend above the belt 309 to contact the terrain. The traction cleat 300 is secured to the inner belt 310 through drive lugs 303, which may be modular or may be molded to the inner surface 307 of the belt. The outside edge of the traction cleat 300 is not connected to drive lugs 303 because the outer belt 311 extends beyond the width of the drive gears of the skidsteer. The rigid traction cleat 300 bridges the gap defined as dimension “g” 305. The inside edge 308 of the inner belt travels alongside the body of the skidsteer and the outside edge 309 extends to the outside edge of the drive system. Mechanical fastening means 304 are used to secure the traction cleat to the belt 301 both through drive lugs 303 and belt surfaces without drive lugs 306.

The underside of the endless track segment 400 shown in FIG. 3 is depicted as the bottom view FIG. 4. The traction cleat 401 is visible through the gap 404 but not through the belt 400. A segment of the traction cleat 401 is secured to drive lugs 402 via a mechanical fastening means 403. A similar mechanical fastening means 406 is used to secure the traction cleat 401 to the outer belt 405 in the absence of drive lugs.

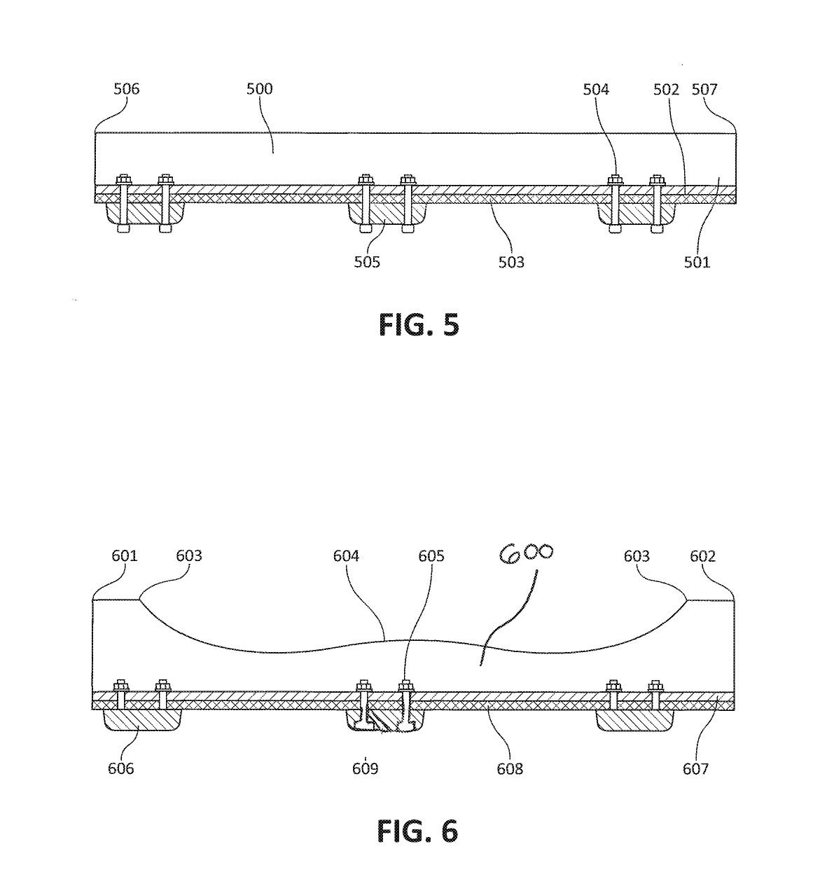

An aspect of the invention using an endless track belt 503 in a one-piece configuration with an external traction cleat 500 is depicted in the front, segment view of FIG. 5. The traction cleat 500 shown extends from the inside, drive edge of the skidsteer at point 507 to the outside of the drive system at point 506. The vertical surface 501 is perpendicular to the horizontal surface 502. The horizontal surface 502 mates to the endless track belt 503. Mechanical fasteners 504, here threaded bolts and nuts, secure the traction cleat 500 to the molded drive lugs 505.

A traction cleat 600 with a u-shaped terrain contacting edge 604 is shown in FIG. 6. The terrain contacting edge 604 of the traction cleat 600 consists of two segments parallel to the horizontal surface 607 of the cleat 600. These segments extend from the inside point 602 of the belt and cleat to the u-shaped transition point 603 and from a second u-shaped transition point 603 to the outside point 601 of the belt. The horizontal surface 607 of the cleat 600 mates to the endless track 608 and is secured to drive lugs 606 via mechanical fastening means 605. One end 605 of the mechanical fastening means according the aspect of the invention shown extend above the horizontal surface 607 of the cleat, and the opposite end 609 is nested inside the drive lugs 606. The belt shown in FIG. 6 is one piece without extensions past the width of the skidsteer's drive rollers.

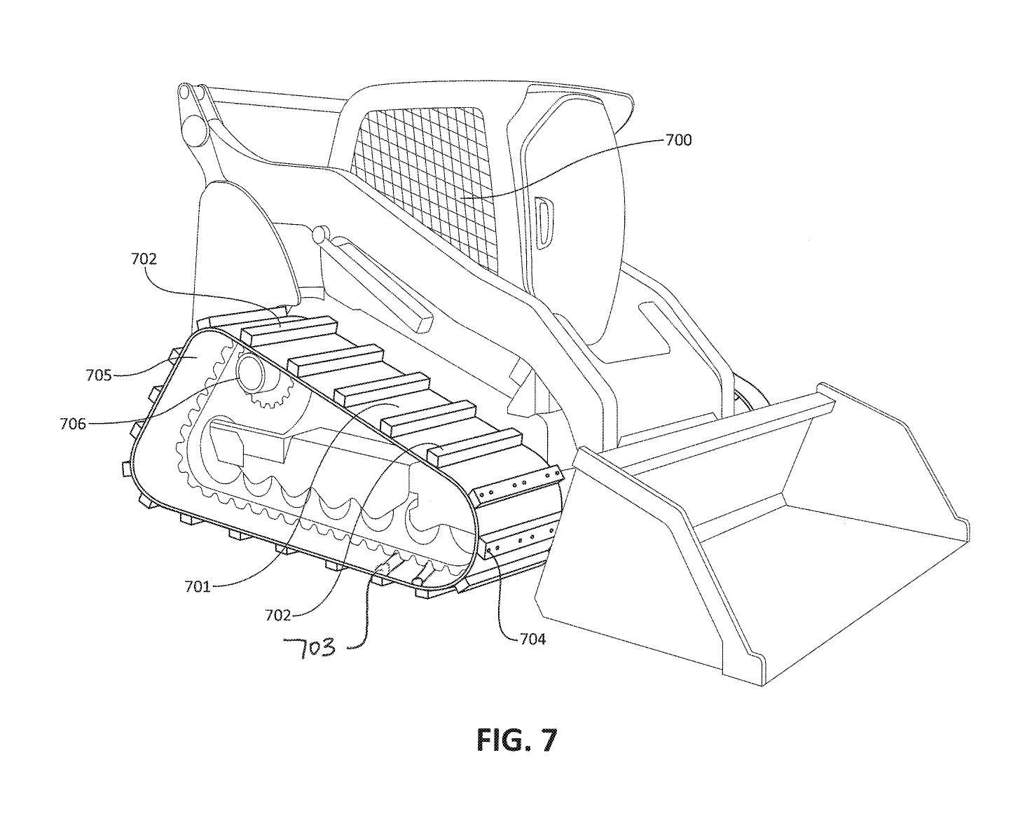

An isometric view of a skidsteer 700 is shown as FIG. 7. The endless track 701 has been fit with hollow, square-shaped traction cleats 702. The square-shaped traction cleats 702 are mated to the terrain-contacting surface of the endless track 701 and are secured to the track 701 via a mechanical fastening means 704 residing in the inner diameter of the cleats 702. Some of the traction cleats 702 are mounted to drive lugs 703 on the inner surface 705 of the endless track 701. The drive lugs 703 are a mix of modular and molded and interact equally well with the drive mechanism 706 of the skidsteer 700.

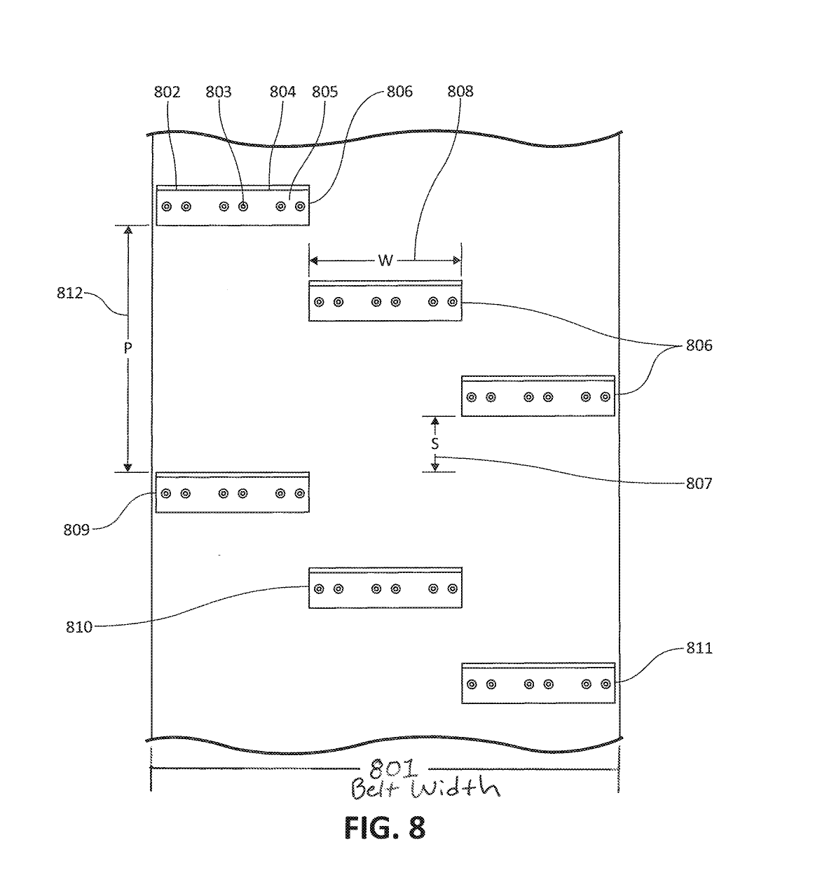

According to certain aspects of the invention, traction cleats 802 may be less than the width of the endless track belt 801 and installed in a horizontally staggered fashion, as depicted in the segment view included in FIG. 8. A horizontal surface 805 of an L-shaped cleat is fastened to the endless belt 801 via a mechanical fastening means 803 while the vertical surface 804 penetrates the terrain. In the embodiment shown, outer 809, center 810, and inner 811 cleats, span the width of the belt 801. The repeating patterns are staggered per dimension “s” 807. The pitch dimension “p” is determined both by the traction needs of the belt, as well as the number of staggered cleats to span the width of the belt 801. Generally, a full repeating pattern 806 of cleats will span the pitch dimension “p” 812. Dimension “w” 808 is calculated by dividing the width of the belt by the number of staggered cleats.

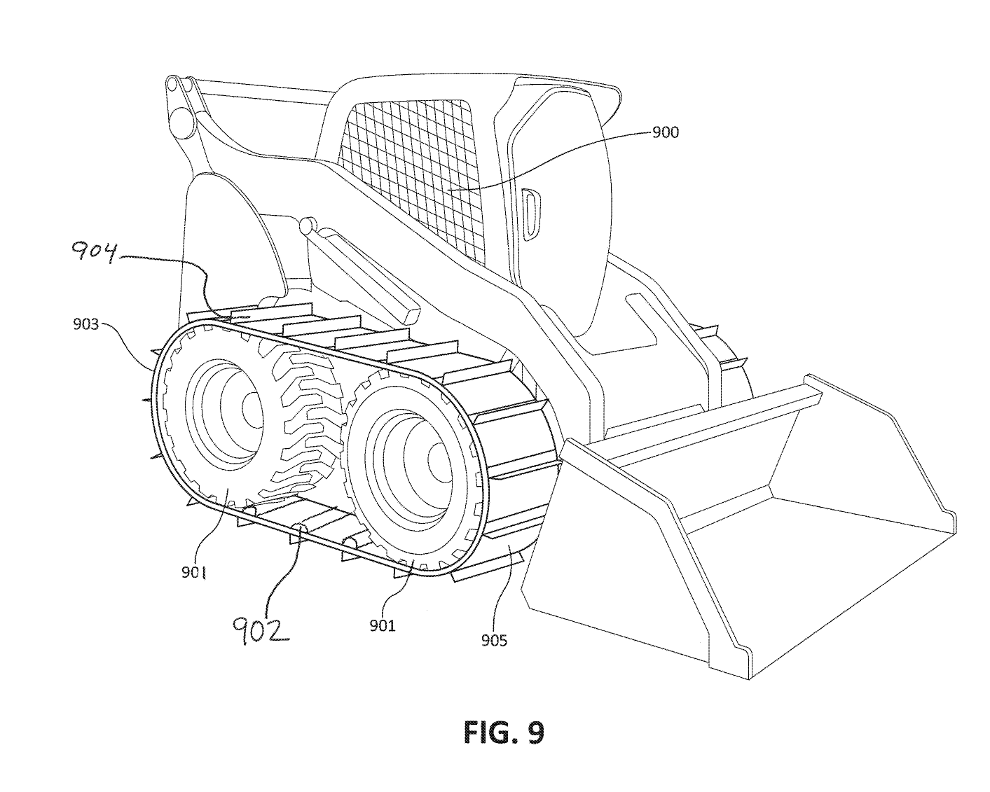

FIG. 9 depicts a skidsteer 900 utilizing four rubber wheels 901 as an alternative to endless tracks. Drive lugs 902 and the endless track 903 length dimension of certain aspects of this invention have been situated and designed to retrofit certain aspects of the invention to this type of skidsteer 900. L-shaped traction cleats 904 are shown on the terrain-contacting surface 905 of the endless track 903.

According to certain embodiments, the two rubber surfaces of the belt are constructed in a single molding process typical of track belt construction. The metal cleats are attached to the belt with a mechanical fastening means that is a bolt according to some embodiments. The snow-tread-skidsteer-track mounts and travels in the same fashion as a belt sold with the skidsteer by the OEM.

The track of the present disclosure is comprised of a series of modular drive lugs, one or more endless belts, and traction cleats. Modular drive lugs are defined as aftermarket drive lugs designed for replacing or retrofitting existing OEM skidsteer tracks. Modular drive lugs are not a feature of an endless track added during a molding process. Instead, the modular drive lugs may replace molded drive lugs that are damaged as a result of belt wear. According to the present disclosure, modular drive lugs are used as a means to add-on traction cleats that were not originally a constituent of an OEM endless track. The traction cleats are secured to the modular drive lugs, through the cross-section of the endless belts with a mechanical fastening means.

According to certain aspects of the invention, the drive lugs are molded to the inner surface of the belt as an alternative to using modular drive lugs. The traction cleats may be secured to the molded drive lugs, but this is not required. Alternatively, the cleats may be secured to the endless track belt via a mechanical fastening means penetrating the cross-section of the belt. According to certain aspects of the invention, the traction cleats are secured to the terrain-contacting surface of the belt via an overmolding process.

The drive lugs are a modular design; modular meaning they may exist as a separate component to be implemented as a stand-alone addition to existing tracks. According to some aspects of the present invention, the cleats are provided as a component for constructing a new track. The materials of construction of the drive lugs consists of fiber reinforced polymers, ultra-high molecular weight plastic (UHMW), polymer coated metal, machined rubber, molded rubber, and metal, or any combination of materials sufficient to provide positive engagement of the track and the drive sprocket and idlers wheels. An example of a fiber-reinforced polymer is a polymer matrix reinforced with fibers. The polymer is commonly epoxy, vinyl, or polyester, and the fibers are commonly glass, carbon fiber, or aramid fibers.

The drive lugs have a flat surface to mate with the track belt and a profile similar to that of an OEM molded rubber drive lug so that they interlock with the machines drive system in a satisfactory way and provide acceptable wear properties and longevity equivalent to or greater than OEM rubber tracks in applicable service conditions. The mechanical fastening means provides the security and force via a clamping mechanism to mate the flat surface of the drive lug to the track belt. The lug provides mounting holes, studs, rivets etc. oriented perpendicular to the mating surface and passing through the same plane in order to intersect the track belting and mechanically engage the outer cleats. The lug may have threaded holes to receive mechanically threaded fasteners or also have holes machined in particular shapes to secure a specific fastener, such as a hex nut threaded to a machine bolt.

The track belting is constructed from internally reinforced vulcanized rubber. The reinforcement materials may include, but are not limited, to: polyester, aramid fibers, Kevlar, metallic wire, nylon, cloth etc. and may be molded in a continuous loop, also known as an endless belt, or having two ends joined together to form a loop. Exemplary methods for splicing two ends together may include mechanical hinging, lacing, a glued scarf, a vulcanized joint, and a lap joint.

The belting of the present invention has integral holes through its cross-section to receive mechanical fasteners for the attachment of drive lugs and traction cleats. One embodiment of the track belting includes metal bushings as reinforcement within the rubber material. These bushings are in a direction parallel to the mechanical fastener length, perpendicular from the horizon for a flat track, and serve to strengthen and define the mechanical fastener holes.

The traction cleats of the present invention may be constructed from several materials including steel, aluminum, plastic, and rubber, and combinations of materials therein. Examples of combinations according to some embodiments are an aluminum frame coated with rubber, or an aluminum frame with a hardened steel insert to provide support specific to terrain conditions.

The cleats of the present invention consist of a flat segment, straight holes in the plane of the flat surface, of a depth dimension equal to its cross-section, and a cleat segment, perpendicular to and displaced horizontally from, the flat segment. The flat segment has a mating surface to contact an outside surface of the track belt. The holes of the flat segment accept fasteners from the drive lugs through the track belt to construct a clamping mechanism for securing the cleat to the track belt. The perpendicular orientation of the cleat segment to the flat segment serves to transfer the drive torque of the machine to the underlying terrain.

The cleats are superimposed on the belt and serve to enhance the traction of the present invention on surfaces requiring enhanced traction, such as snow-covered incline slopes. According to one embodiment, the cleats are of equal width arranged perpendicular to the direction of the belt's travel over the implements drive system. The cleats may span the width of a track belt. Alternatively, the width of the cleats may be a fraction of the width of the drive belt and installed in a horizontally staggered configuration a direction that is transverse to the driven direction of the belt. In the horizontally staggered configuration of certain embodiments, no single cleat spans the entire width of the belt, but instead the width of the belt is spanned by a serious of cleats each having a width less than the width of the belt.

The cleats are offset from the outside edge of the belt towards the inside, or machine edge of the belt, by the width of each successive cleat. The proportional width of a cleat determines the number required to span the width of the belt. For example, the width of the cleat may be one-third the width of the belt. A first cleat is placed at the outside edge of the belt, a second cleat placed in the center third, but offset by a longitudinal distance, and a third cleat placed the same longitudinal distance forward, but spanning a one-third width of the belt to reach the inside, or machine edge of the belt. The width of offset cleats is determined by the traction needs of the application, the material of construction of the cleats, and the permitted impact of specialized terrain such as muskeg, snow-covered inclines, and ice-covered surfaces.

The offset pattern of cleats may also be used to span open spaces on drive systems utilizing multiple belts. Also according to some embodiments, cleats that span the entire width of the belt, and are not installed in an offset pattern, may also be used to span open spaces of multi-belt systems. Cleats may integrate the securing portion of the mechanical fastener originating from the drive lug, i.e. a tapped hole or a provision for a secondary fastener including but not limited to; nut and washer, hardened plate with tapped holes, captive nut strip etc. According to some embodiments, the modular cleats include modifications functioning as secondary traction aides such as serrated edges, ice spikes, and end caps.

According to an aspect of the invention, the overall width of the track is equal to the Original Equipment Manufacturer's (OEM) width dimension. The cleat design of these embodiments provides a capability for a machine to function in loose, soft or slippery conditions with a sharper terrain-contacting edge, thus having increased traction in comparison to an OEM track. Additionally, the cleats of this invention will have a greater pitch than the molded cleats of OEM rubber tracks. Pitch is defined as the distance between cleats on the tread side of a track, and the distance between drive lugs on the underside of the track. The cleats are taller than the molded rubber cleats of the OEM belt, not so tall (the distance between the top edge of the cleat to the belt surface), to result in a brittle cleat or a durability loss that will limit the machines ability to traverse hard ground. According to some aspects, the cleat may be square, u-shaped, or a combination thereof.

Another aspect of the invention is suited for applications primarily concerned with operation in snowy conditions. The tracks of these embodiments are arranged in a width dimension greater than OEM tracks. This results in a track belt and cleats that extend beyond the width of the machine's drive undercarriage that contacts the drive lugs of the belt. The purpose of this arrangement is to lower the ground pressure of the machine increasing flotation properties while keeping the undercarriage closer to the centerline of the machine so as to decrease bearing loads and contact with hydraulic plumbing and control system hardware.

In the present disclosure, the main purpose for asymmetrical tracks is to reduce ground pressure, increase flotation and tractive effort within the original track contact length and to require no modification of the undercarriage of the machine. Cleats for this embodiment will have a taller and sharper profile to penetrate snow and ice terrains. Other aspects of the invention include cleat shapes consisting of ice spikes and/or end caps spaced out in a pattern that optimizes traction, yet minimizes weight and turning force required for acceptable machine handling characteristics.

Cleats may be of equal length, spanning the entire width of the track or of a staggered pattern having a full-length cleat then a shorter cleat that only spans the inner belt or width of the OEM track and under carriage. The cleats may be shaped metal or may be smaller components of fabricated metal such as pipe end caps. The end caps are from shaped tubing and may be round, square, or rectangular in shape. They are mounted in an orientation where the open face of the end cap is joined to a flat piece of metal for securing to the belt or drive lugs. The closed face of the end cap is used to contact, penetrate, and grip the terrain. Alternatively, a mechanical fastener may be recessed, countersunk, or joined to the closed face of the end cap at one of its ends, and its opposite end extends through the track and secures the end cap to the drive side of the endless belt or a modular drive lug. Mechanical fastening alternatives refer to mechanical fastening means of all aspects and embodiments of the present disclosure.

Another aspect of the invention is a track belt with modular lugs and a cleat designed for use on hard bottomed terrain with a soft covering, such as a paved roadway or parking lot covered by fresh snow. According to this aspect, the tracks would consist of cleats arranged in a fashion to maximize ground pressure while enhancing forward traction with the installation of a cleat acting as a cutting surface. This arrangement is especially applicable to terrain surfaces with a soft covering for penetration of the traction cleat, but containing a hard terrain surface underneath the soft covering where minimal contact is desired. This is accomplished by a cleat height and profile with a minimum edge thickness acceptable to provide smooth travel and machine operation over said terrain examples.

This embodiment would utilize a cleat made up of a combination of materials chosen for their grip on slippery terrain and would be beneficial in the snow and ice removal industry. Examples of material combinations for the cleat component include aluminum cleats overmolded with vulcanized rubber, hard rubber cleats, angle or L-shaped polymer material, angle or L-shaped fiber-reinforced polymers, and combinations therein.

An aspect of the current invention is an endless, flexible, track for use on track-driven implements comprising an inner surface, modular drive lugs to engage a driving mechanism of the implement, and interchangeable traction cleats spanning the width of the track. Integral is defined as: the through holes are within the body of the belt and are not visible once the modular drive lugs have been bolted to the traction cleats. The modular drive lugs have integral through-holes to receive a fastening means and are mounted to the inner surface of the belt. The outer surface of the belt contacts the terrain and is comprised of a slick rubber surface. The width of the belt is between 11 inches and 22 inches, according to some aspects of the invention. Implement traction and drive efficiency may be optimized for some terrain applications if the pitch of the traction cleats is equal to the pitch of the drive cleats. According to another aspect of the invention for use on other terrain applications susceptible to damage from traction cleats, the pitch of the traction cleats is between ½ and ¼ the pitch of the drive lugs. Another aspect of the invention comprises a configuration wherein the width of individual traction cleats are one-third to one-half the width of the track, and the traction cleats are installed in a horizontally staggered position. The staggering of the traction cleats is dictated by a pitch of the staggered cleats equal to the pitch of the drive lugs multiplied by the fraction of the belt width that is the width of the traction cleats. This serves to create an optimal match of cleat pitch to a specific terrain.

According to other aspects of the invention, the shape of the traction cleat is an L-shaped angle material. A horizontal segment of the L-shape contacts the outer surface of the track and a vertical segment, connected to the horizontal segment of the L-shape, serves as a traction-enhancing means. The L-shaped bracket is dimensioned with the length of the horizontal segment of the L-shape is between 1.25 inches and 3 inches, and the length of the vertical segment of the L-shape is between 0.5 inches and 2.0 inches.

Another aspect of the invention is a multi-piece belt with a gap to reduce ground pressure, improve flotation, and adapt the invention to additional track-driven implements. This consists of an endless, flexible, track for use on track-driven implements comprising an inner belt and an outer belt with a gap between the two belts, and drive lugs mounted to the drive side of the inner and outer belts to engage a driving mechanism of the implement, the drive lugs having through-holes to receive a fastening means and mounted to the inner surface of the track. The drive lugs may be modular. The outer surface of the endless belt contacts terrain, the outer surface being comprised of a slick rubber surface, and interchangeable traction cleats bridge a gap between the inner and outer belts, spanning the width of the track. To provide balance to the two-track with gap aspect, the width of the gap between the inner and outer belts is equal to the width of the inner belt, and the gap has a dimension between 2 inches and 6 inches.

According to another aspect of the invention, the traction cleat is an L-shaped angle material; a horizontal segment of the L-shape contacts the outer surface of the track, a vertical segment, connected to the horizontal segment of the L-shape serves as a traction-enhancing means, and the angle material spans the gap between the inner and outer belts. The shape of the traction cleat according to some aspects is an L-shape, but other shapes pertain to additional aspects of the invention, depending on the desired tread pattern and traction requirements dictated by the terrain type and machine size.

According to some aspects of the invention, the traction cleat is a shaped metal extrusion with a horizontal segment to contact the outer surface of the track, and a polygon-shaped vertical segment to serve as a terrain penetrating means, and specifically, the polygon-shaped vertical segment is chosen from the group consisting of: triangle, rectangle, square, semi-circle, trapezoid, rhombus, parallelogram, triangle-on-square, triangle-on-rectangle, pentagon, hexagon, octagon, six-point star, five-point star, crescent moon.

One aspect of the present disclosure is the modular nature of the track. This permits a tailoring of the invention to specialized terrain types currently underserved by commercially available machines. The method of making an aspect of the present invention, an endless track suited for use on low-friction applications is comprised of assembling an endless track constructed of a flexible elastomeric rubber, wherein the endless track has an inner surface to engage a drive system of a track-driven implement and an outer, terrain-contacting surface. Modular drive lugs are subsequently fastened through holes travelling through a cross-section of the endless track. While the modular drive lug is mounted to the underside, or inner surface, of the endless track in order to contact the implement's drive mechanism, the outer surface of the endless track, or alternatively described as the topside or terrain-contacting surface of the track, is the location to mechanically fasten a traction cleat. The mechanical fastening means extends through a cross-section of the endless track and attaches the traction cleats to the modular drive lugs. Alternatively, the drive lugs may be molded.

According to certain aspects of the invention, the cross-section of the endless track contains a metal bushing to reinforce the hole of the cross-section of the endless track. Additionally, the fastening means to secure the modular drive lug to the traction cleat is one of the group consisting of: threaded bolt to a threaded nut secured in the drive lug through a machined opening mated to the threaded nut, rivets, hollow rods attached to the traction cleat to mate to drilled holes of the modular drive lug, studs integral to the traction cleat, studs integral to the modular drive lug, and combinations therein.

According to certain aspects of the invention, the endless, flexible track has the drive lugs mounted to the drive surface of the belt, are modular and, are constructed with through-holes to receive a fastening means and mounted to the drive surface of the belt. In addition, according to other aspects and embodiments of the present invention, the drive lugs are configured to install the flexible track over four rubber drive wheels of wheel-driven skidsteer implements. According to certain aspects of the invention, the method to manufacture the endless track will include steps to secure metal bushings through the cross-section of the endless track. According to certain aspects, the method to secure metal bushings to accommodate a fastening means within the endless track is an overmolding process. The drive lugs may also be molded.

The metal bushings serve to reinforce the holes used by mechanical fastening means for securing the traction cleats. The traction cleats may also be fastened to the endless track through its cross-section without being fastened to the drive lugs. The fastening means to secure the modular drive lug to the traction cleat is one of the group consisting of: threaded bolt to a threaded nut secured in the drive lug through a machined opening mated to the threaded nut, rivets, hollow rods attached to the traction cleat to mate to drilled holes of the modular drive lug, studs integral to the traction cleat, studs integral to the modular drive lug, and combinations therein. According to certain aspects of the invention, the drive lugs are fastened to the inner surface of the endless track via a molding process used to form the endless track.

1. An endless, flexible, track for use on track-driven implements comprising:
an inner surface;
molded drive lugs to engage a driving mechanism of the implement, the drive lugs having through-holes to receive a fastening means and mounted to the inner surface of the track;
an outer surface to contact terrain, the outer surface being comprised of a slick rubber surface, and;
interchangeable traction cleats spanning the width of the track.

2. The track of claim 1, wherein the drive lugs are modular.

3. The track of claim 1, wherein the width of the track is between 11 inches and 22 inches.

4. The track of claim 1, wherein the pitch of the traction cleats is equal to the pitch of the drive cleats.

5. The track of claim 1, wherein the pitch of the traction cleats is between ½ and ¼ the pitch of the drive cleats.

6. The track of claim 1, wherein the width of individual traction cleats is one-third to one-half the width of the track, and the traction cleats are installed in a horizontally staggered position.

7. The track of claim 6, wherein the pitch of the horizontally staggered cleats is equal to the pitch of the drive lugs multiplied by the fraction of the track width that is the width of the traction cleats.

8. The track of claim 1, wherein the width of the individual traction cleats is one-fourth to one-sixth the width of the track, and the traction cleats are installed in a horizontally staggered position.

9. The track of claim 1, wherein the shape of the traction cleat is an L-shaped angle material; a horizontal segment of the L-shape contacts the outer surface of the track, a vertical segment, connected to the horizontal segment of the L-shape serves as a traction-enhancing means

10. The track of claim 9, wherein the traction cleats are L-shaped and the length of a horizontal segment of the L-shape is between 1.25 inches and 3 inches.

11. The track of claim 9 wherein the length of a vertical segment of the L-shape is between 0.5 inches and 2.0 inches.

12. The track of claim 1 wherein the traction cleats are comprised of metal ice spikes welded to a flat piece of metal secured to the modular drive lugs.

13. The track of claim 1 wherein the traction cleats are comprised of closed end caps for metal tubing.

14. The track of claim 13 wherein the endcaps are square, round, or rectangular.

15. An endless, flexible, track for use on track-driven implements comprising:
An inner belt and an outer belt with a gap between the two belts;
drive lugs molded to a drive side of the inner the outer belts to engage a driving mechanism of the implement,
a terrain-contacting surface, the terrain-contacting surface being comprised of a slick rubber surface, and
interchangeable traction cleats that span the width of the track to bridge a gap between the inner and outer belts.

16. The endless, flexible track according to claim 15 wherein the drive lugs are mounted to the drive surface of the belt,
are modular, and
are constructed with through-holes to receive a fastening means and mounted to the drive surface of the belt.

17. The endless, flexible track according to claim 15 wherein the drive lugs are configured to install the flexible track over four rubber drive wheels of wheel-driven skidsteer implements.

18. The track according to claim 15, wherein the width of the gap between the inner and outer belts is equal to the width of the outer belt.

19. The track according to claim 15, wherein the width of the gap and the inner belt is between 2 inches and 6 inches.

20. The track according to claim 15, wherein the traction cleat is an L-shaped angle material; a horizontal segment of the L-shape contacts the terrain-contacting surface of the track, a vertical segment of the traction cleat is connected to the horizontal segment to serve as a traction-enhancing means, and the angle material spans the gap between the inner and outer belts.

21. The track according to claim 15, wherein the traction cleat is a shaped metal extrusion with a horizontal segment to contact the outer surface of the track, and a polygon-shaped vertical segment to serve as a terrain penetrating means.

22. The traction cleat according to claim 21 wherein the polygon-shaped vertical segment is chosen from the group consisting of: triangle, rectangle, square, semi-circle, trapezoid, rhombus, parallelogram, triangle-on-square, triangle-on-rectangle, pentagon, hexagon, octagon, six-point star, five-point star, crescent moon.

23. A method of making an endless track suited for use on low-friction applications comprising:
Assembling an endless track constructed of a flexible elastomeric rubber;
The endless track having an inner surface to engage a drive system of a track-driven implement and an outer, terrain-contacting surface;
fastening a drive lug through a hole travelling through a cross-section of the endless track;
the drive lug being fastened to a traction cleat mounted on the outer, terrain-contacting surface of the endless track.

24. The method according to claim 23 wherein the cross-section of the endless track contains a metal bushing to reinforce the hole of the cross-section of the endless track.

25. The method according to claim 23 wherein the metal bushings are secured in the endless track via an overmolding process.

26. The method according to claim 23 wherein the fastening means to secure the modular drive lug to the traction cleat is one of the group consisting of: threaded bolt to a threaded nut secured in the drive lug through a machined opening mated to the threaded nut, rivets, hollow rods attached to the traction cleat to mate to drilled holes of the modular drive lug, studs integral to the traction cleat, studs integral to the modular drive lug, and combinations therein.

27. The method of claim 23 wherein the traction cleats are mounted to the endless track belt without being secured to drive lugs.

28. The method of claim 23 wherein the traction cleats are mounted to the terrain contacting surface of the endless track belt via an overmolding process.

29. The method of claim 23 wherein the drive lugs are fastened to the inner surface of the endless track via a molding process used to form the endless track.

30. The method of claim 23 wherein the traction cleats are fastened to the endless track through its cross-section without being fastened to the drive lugs.
